(19) United States
(12) Patent Application Publication
(10) Pub. No.: US 2026/0128929 A1
(43) Pub. Date: May 7, 2026

(54) WASSERSTEIN GENERATIVE ADVERSARIAL NETWORKS FOR FREQUENCY-DOMAIN CHANNEL ESTIMATION

(71) Applicant: Samsung Electronics Co., Ltd., Gyeonggi-do (KR)

(72) Inventors: Mirette SADEK, San Diego, CA (US); Jung Hyun BAE, San Diego, CA (US); Dongwoon BAI, San Diego, CA (US)

(21) Appl. No.: 19/370,231

(22) Filed: Oct. 27, 2025

Related U.S. Application Data
(60) Provisional application No. 63/716,498, filed on Nov. 5, 2024.

(51) Int. Cl. H04L 25/02; H04L 5/00; H04L 27/26

(52) U.S. Cl. CPC H04L 25/0256; H04L 5/0007; H04L 27/261

(57) ABSTRACT

Methods and devices of a wireless system are provided. A generator in a generative adversarial network (GAN) is trained using generator training data including cluster delay line (CDL) channel samples. The generator is trained to generate a trained generator and generated samples. The GAN is configured to transform, through utilization of a Fourier transform, sample, and truncate the generator training data as latent input to the generator. A discriminator in the GAN is trained using discriminator training data including CDL channel samples. A signal is received at a UE receiver. A CDL channel at the UE receiver is estimated in a frequency domain using a received noisy DMRS through utilization of the trained generator. The trained generator uses truncated, sampled Fourier transform representations of the received signal as latent input. Based on the estimated channel, an equalized signal is generated from the received signal.

### CROSS-REFERENCE TO RELATED APPLICATION

This application claims the priority benefit under 35 U.S.C. § 119(e) of U.S. Provisional Application No. 63/716,498, filed on Nov. 5, 2024, the disclosure of which is incorporated by reference in its entirety as if fully set forth herein.

### TECHNICAL FIELD

The disclosure generally relates to wireless communications. More particularly, the subject matter disclosed herein relates to improvements in machine learning for channel estimation.

### SUMMARY

In wireless systems, channel estimation (CE) may be used to estimate the effects of a channel on data transmitted through a wireless medium. Channel estimation may be used for equalization, beamforming, and/or adaptive modulation.

Some algorithms for channel estimation may be configured for analog channels. Some algorithms for channel estimation may be configured for time-invariant channels. Some algorithms for channel estimation may be configured for frequency-flat channels.

Algorithms for channel estimation such as, for example, linear minimum mean squared error (LMMSE), may be highly dependent on the validity of the channel model assumed and the accuracy of the model parameters used for estimation. For a tapped delay line (TDL) channel model, performance of conventional algorithms may be sensitive to parameter estimates such as, for example, power delay profile (PDP) and signal-to-noise ratio (SNR). For a cluster delay line (CDL) channel model, conventional approaches often fall short due to model inaccuracy and/or model complexity.

Frequency-domain (FD) channel estimation typically assumes some well-known stochastic channel model, and target estimating model parameters in order to adapt a basic algorithm. These model parameters may include a channel maximum delay spread, a complete PDP, and/or a Doppler frequency.

Channel estimation algorithms often fall short when accurate channel model parameters estimation is not guaranteed. Channel estimation algorithms often fall short when a channel model is approximate. Channel estimation algorithms often fall short when channel models are too complex and need too many parameters. Channel estimation algorithms also may not achieve desired channel estimation quality.

Systems and methods are described herein for learning-based channel estimation. Learning-based channel estimation may provide higher estimation quality than conventional approaches.

Disclosed systems and methods may include transforming generator input as latent input to a generator. Disclosed systems and methods may improve on previous methods because latent vector input may lead to better inference in terms of normalized mean squared error (NMSE). Therefore, the disclosed systems and methods may offer improvements to channel estimation quality over conventional approaches. Disclosed systems and methods may outperform conventional approaches in terms of uncoded bit error rate (UCBER), coded bit error rate (BER), and/or block error rate (BLER).

In an embodiment, a method comprises training, using generator training data including CDL channel samples, a generator in a generative adversarial network (GAN) to generate a trained generator and generated samples. The GAN is configured to transform, through utilization of a Fourier transform, sample, and truncate the generator training data as latent input to the generator. The method comprises training, using discriminator training data including CDL channel samples, a discriminator in the GAN. The method comprises receiving a signal at a user equipment (UE) receiver. The method comprises estimating a CDL channel at the UE receiver in a frequency domain using a received noisy demodulation reference signal (DMRS) through utilization of the trained generator. The trained generator uses truncated, sampled Fourier transform representations of the received signal as latent input. The method comprises using the estimate of the CDL channel, generating an equalized signal from the received signal.

In an embodiment, a UE comprises at least one processor, a receiver, and memory that stores instructions, which when executed by the at least one processor, control the UE to receive a signal at the receiver. The instructions, when executed by the at least one processor, control the UE to estimate a CDL channel received at the receiver in a frequency domain using a received noisy DMRS through utilization of a trained generator. The trained generator uses truncated, sampled Fourier transform representations of the received signal as latent input. The instructions, when executed by the at least one processor, control the UE to generate an equalized signal from the received signal using the estimate of the CDL channel.

In an embodiment, a method is performed by a UE. The method comprises receiving a noisy DMRS. The method comprises estimating a CDL channel in a frequency domain using the received DMRS through utilization of a trained generator. The trained generator uses truncated, sampled Fourier transform representations of the received signal as latent input. The method comprises using the estimate of the CDL channel, generating an equalized signal from the received signal.

### BRIEF DESCRIPTION OF THE DRAWING

In the following section, the aspects of the subject matter disclosed herein will be described with reference to exemplary embodiments illustrated in the figures, in which:

FIG. 1 is a block diagram illustrating a UE in communication with a trained generator, according to an embodiment;

FIG. 2 is a block diagram illustrating a UE including a trained generator, according to an embodiment;

FIG. 3 is a block diagram illustrating a TA-GAN in a training phase, according to an embodiment;

FIG. 4 is a block diagram illustrating a WGAN channel estimation, according to an embodiment;

FIG. 5 is a diagram illustrating a channel estimation model for an OFDM subframe, according to an embodiment;

FIG. 6 is a flowchart illustrating a method for training a GAN and estimating a channel, according to an embodiment;

FIG. 7 is a flowchart illustrating a method for estimating a CDL channel, according to an embodiment;

FIG. 8 is a block diagram of an electronic device in a network environment, according to an embodiment; and

FIG. 9 shows a system including a UE and a gNB in communication with each other.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “auto-covariance,” etc.) may be occasionally interchangeably used with a corresponding non-hyphenated version (e.g., “two dimensional,” “predetermined,” “auto covariance,” etc.), and a capitalized entry (e.g., “Channel Estimation,” “Noise,” “Generative Adversarial Network,” etc.) may be interchangeably used with a corresponding non-capitalized version (e.g., “channel estimation,” “noise,” “generative adversarial network,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

“Channel estimation (CE)” as used herein refers to systems and methods used to estimate the effects of a channel on data transmitted through a wireless medium.

“Cluster delay line (CDL)” as used herein refers to a type of radio propagation channel model for a received signal that is composed of a number of separate delayed clusters. Each cluster may comprise a number of multipath components with the same delay. Multipath components may comprise different angles of arrival. A CDL channel model may be configured to characterize time-varying and frequency-selective aspects of a wireless channel.

“CDL-A” as used herein refers to a specific channel model defined by the 3rd Generation Partnership Project (3GPP) in fifth generation (5G) new radio (NR) systems. A CDL-A model may be used in a non-line-of-sight (NLOS) environment.

“Physical downlink shared channel (PDSCH)” as used herein refers to a component of downlink communication in 5G wireless communication systems. A PDSCH may carry user data and system information from a base station to a UE. A PDSCH is a shared resource that may be dynamically allocated by a network and can be configured with various options for its mapping, modulation, and coding.

“Normalized mean square error (NMSE)” as used herein refers to a metric that may be used to evaluate the accuracy of a predictive model.

“Generative adversarial network (GAN)” as used herein refers to a machine learning framework comprising two components: a generator and a discriminator. A generator may comprise a deep neural network configured to generate realistic data samples. A generator may be configured to minimize a generator loss function. A discriminator may comprise a classifier configured to distinguish between real samples and generated samples. A discriminator may be configured to minimize a discriminator loss function. The generator and the discriminator may be trained together in an adversary manner. GANs belong to the generative AI set of artificial intelligence (AI) algorithms. Generative AI algorithms are typically used to generate realistic data samples that resemble the same probability distribution that describes a set of training data.

“Wasserstein GAN (WGAN)” as used herein refers to a variant of a GAN that may be configured to provide more stable training and/or higher quality samples. WGANs may utilize a different loss function than a traditional GAN. In WGANs, a discriminator may be referred to as a critic. The critic may be configured to output a value score rather than a binary decision in many traditional discriminators. During the WGAN training phase, a critic may be updated several times before a generator is updated once.

“Transform-assisted Wasserstein GAN (TA-GAN)” as used herein refers to a GAN configured to utilize a truncated, sampled Fourier transform representation of channel samples as a latent input to a generator during both training and inference.

Embodiments consistent with the present disclosure may include a GAN. The GAN may comprise a WGAN. The GAN may comprise a TA-GAN. The GAN may be configured to estimate a one-dimensional (1D) frequency-domain channel vector. The 1D frequency-domain channel vector may comprise a channel at different subcarriers in an Orthogonal Frequency Division Multiplexing (OFDM) symbol. The channel may carry a DMRS. A TA-GAN may be utilized for CDL channel estimation in a frequency-domain. The TA-GAN may be configured to leverage the sparsity of the channel in the delay domain.

In an embodiment, a method may comprise receiving a signal at a UE receiver. The method may comprise training a generator in a GAN to generate a trained generator and generated samples. The generator may be trained using generator training data. The generator training data may comprise CDL channel samples. The GAN may be configured to transform, sample, and truncate the generator training data. The GAN may be configured to transform the generator training data through utilization of a Fourier transform. The transformed, sampled, and truncated generator training data may be used as latent input to the generator. The latent input to the generator may comprise DMRS or pilot symbol data. The method may comprise training a discriminator in the GAN. The discriminator may be trained using discriminator training data. The discriminator training data may comprise CDL channel samples. The CDL channel samples in the discriminator training data may be from the same dataset as the CDL channel samples in the generator training data. The method may comprise estimating a CDL channel in a frequency domain. A noisy DMRS may be received at a receiver. The DMRS may comprise pilot symbol data. Estimating the CDL channel may comprise utilization of the trained generator. The trained generator may use truncated, sampled Fourier transform representations of the received signal as latent input. The method may comprise using the estimate of the CDL channel, generating an equalized signal from the received signal.

Embodiments consistent with the present disclosure may include truncated, sampled Fourier transform representations of generator training data. The truncated, sampled Fourier transform representations of the generator training data may be in the delay domain. In other words, the truncated, sampled Fourier transform representations of the generator training data may be non-random.

Embodiments consistent with the present disclosure may include truncated, sampled Fourier transform representations of a received signal. The truncated, sampled Fourier transform representations of the received signal may be in the delay domain. In other words, the truncated, sampled Fourier transform representations of the received signal may be non-random.

Embodiments consistent with the present disclosure may include a UE. The UE may be configured to receive a noisy DMRS. The DMRS may be carried by an OFDM symbol.

In an embodiment, a generator loss function may be modified during training of a generator. The generator loss function may comprise a Wasserstein loss. The generator loss function may be modified to include a NMSE. The NMSE may be based on a result of a current iteration of a trained generator.

In an embodiment, a UE may comprise at least one processor, a receiver, and memory that stores instructions. The instructions, when executed by the at least one processor, may control the UE to receive a signal at the receiver. The instructions may also control the UE to estimate a CDL channel, received at the receiver, in a frequency domain using a received noisy DMRS. Estimation of the CDL channel may comprise utilization of a trained generator. The trained generator may utilize truncated, sampled Fourier transform representations of the received signal as latent input. The instructions may also control the UE to generate an equalized signal from the received signal using the estimate of the CDL channel.

In an embodiment, a method is performed by a UE. The method may comprise receiving a noisy DMRS. The method may comprise estimating a CDL channel in a frequency domain using the received DMRS through utilization of a trained generator. The trained generator uses truncated, sampled Fourier transform representations of the received signal as latent input. The method may comprise using the estimate of the CDL channel, generating an equalized signal from the received signal.

Embodiments consistent with the present disclosure may be configured for use on a low-Doppler channel. For a low-Doppler channel, a “warm start” modification may be provided to a TA-GAN algorithm. During the inference phase, the initial value of latent vector used as an input to a generator may be obtained from the latest latent vector from a previous channel estimation cycle, exploiting the relatively high time-coherence of the channel at low Doppler frequencies. This may reduce the number of iterations required to optimize the generator input during the inference phase.

In an embodiment, a learning rate used in training a TA-GAN may be set differently for a generator and a discriminator, where the discriminator has a low constant learning rate, and the generator has a decaying learning rate. The decaying learning rate may start at a value that is, for example, 10 times a steady state value. The decaying learning rate may decay over a period of time.

In an embodiment, a UE, configured to receive a DMRS carried by an OFDM symbol, may be configured to receive frequency domain signal y_{k,l} for a single receive antenna at subcarrier k and OFDM symbol l may be represented by:

$$y ( k , l ) = H ( k , l ) x ( k , l ) + v ( k , l ) \qquad ( 1 )$$

In Equation (1), H(k, l) is the complex frequency domain channel, x(k, l) is the complex transmitted precoded signal, and v(k, l) is the complex thermal noise at subcarrier k and OFDM symbol l. The least-squares (LS) channel estimate at the DMRS subcarriers at a certain OFDM symbol through multiplying by the conjugate of the DMRS signal (x(k, l)) at those locations p, where p is a pair (k, l) representing DMRS signal locations.

$${\hat{H}}_{L S} ( p ) = y ( p ) {x}^{*} ( p ) \qquad ( 2 )$$

Thus, the LS channel estimate is related to the actual channel as shown in Equation (3).

$${\hat{H}}_{L S} ( p ) = H ( p ) + n ( p ) \qquad ( 3 )$$

In Equation (3), the noise term n(p)=x*(p)v(p). The LS channel estimate Ĥ_{LS}(p) is then used to obtain the channel estimate at the data locations. One widely adopted method is through LMMSE estimation.

The channel impulse response (CIR) vector in the delay-domain may be denoted as h and the channel frequency response vector in the frequency domain be denoted as H.

The relation between h and H may be represented by Equation (4), with A defined as the FFT matrix.

$$H = A h \qquad ( 4 )$$

With the channel maximum delay spread being M samples in the delay-domain, without loss of information, the N×1 frequency-domain channel vector can be obtained through only M samples of the CIR vector using a truncated FFT matrix as shown in Equation (5).

$$[ \begin{matrix}{H}_{0} \\ {H}_{1} \\ ⋮ \\ {H}_{N - 1}\end{matrix} ] = [ \begin{matrix}{A}_{0 , 0} & & {A}_{0 , 1} & … & {A}_{0 , M - 1} \\ & ⋮ & & ⋱ & ⋮ \\ {A}_{N - 1 , 0} & & {A}_{N - 1 , 1} & … & {A}_{N - 1 , M - 1}\end{matrix} ] [ \begin{matrix}{h}_{0} \\ {h}_{1} \\ ⋮ \\ {h}_{M - 1}\end{matrix} ] \qquad ( 5 )$$

The CIR h is a sparse vector, with a few non-zero elements, located in the first few positions of the vector depending on the exact channel maximum delay spread.

Due to the sparsity of the CIR, the number n of non-zero elements (channel taps) is expected to satisfy n<<M. This means that the delay-domain CIR has a structure with a few non-zero values in specific positions. This makes the delay-domain channel (CIR) a good candidate for a generative learning algorithm.

In an embodiment, a process may include training a generator in a WGAN channel estimation to output realistic delay-domain channel samples resembling h. The process may include using the trained generator as part of an inference algorithm that takes as an input the LS channel estimation Ĥ_{LS} to iteratively modify the generator output ĥ. The process may include using the output to obtain the frequency domain channel estimate at the data locations using equation (5).

Latent variables, or a latent space, may be referred to as a projection or compression of a data distribution. That is, a latent space provides a compression or high-level concepts of the observed raw data such as the input data distribution.

In the case of GANs, a generator model applies meaning to points in a chosen latent space, such that new points drawn from the latent space can be provided to the generator model as input and used to generate new and different output examples.

Machine-learning models may be configured to learn the statistical latent space of images, music, and stories, and they can then sample from this space, creating new artworks with characteristics similar to those the model has seen in its training data.

An example of generating a realistic output space may include, if an input to a generator model is a random sample, then the corresponding generator model output is a random sample as well that belongs to the output space. For example, a random input may be used to generate a random image that has the same properties as a real image (i.e., belongs to the same image space). This may be used for data set augmentation for example as well as other applications.

In some embodiments, an input to a generator model is not random. The input may comprise a specific point in a latent space. The generator model output may be a specific desired output in an output space. A GAN may be used as a decoder (part of an autoencoder) that takes in a compressed representation (point in latent space) and transforms it into a full representation (a point in the output space).

A difference between WGANs and GANs is the use of a different loss function, namely the Wasserstein distance, also known as the earth-mover (EM) distance.

The EM distance between x, y may be represented by:

$$W ( {r}_{} , {g}_{} ) = ( ′ ) {inf}_{γ ∈ \prod ( {r}_{} , {g}_{} )} {( x , y ) ∼ γ}_{} [ ‖ x - y ‖ ] \qquad ( 6 )$$

In Equation (6), Π( [symbol] ᵣ, [symbol] ₐ) is the set of all joint distributions γ(x, y) whose marginal are [symbol] ᵣ, and [symbol] _{g}, respectively.

This loss function may result in a soft discriminator output that may indicate the “realness” or “fakeness” of the generated sample. A benefit of using a WGAN is that the training process is more stable and less sensitive to model architecture and choice of hyper-parameter configurations.

In an embodiment, hyper-parameter values may be used for WGAN training. Example parameters and values are summarized in Table 1.

TABLE 1
Dimensions and Hyper-parameters

| Parameter | Value |
|---|---|
| Channel vector | 14 × 1 |
| Latent dimension | 15 × 1 |
| Ratio of discriminator update | 20 |
| to generator update | |
| Learning Rate | Generator: decays from 1e−5 |
| | to 1e−6 over 1000 epochs; |
| | Discriminator: 1e−6 |
| Mini batch size | 200 |
| Training epochs | 100k |

In an embodiment, a WGAN channel estimation algorithm may include training a generator, as part of a WGAN, offline to produce realistic CIR vectors. The WGAN channel estimation may include using the pre-trained generator as part of a channel estimation algorithm. This involves using an input latent vector to the generator which is not random, but rather obtained as a function of the channel DMRS values.

In an embodiment, an optimization-based latent vector z* may be used to obtain a generator input from DMRS. An optimization-based WGAN channel estimation may start with an initial z₀. An optimum latent vector z* may be iteratively obtained. After obtaining the initial z₀, the channel DMRS values are then used to iteratively optimize the latent vector. An iterative optimization algorithm may obtain the optimum latent vector z* that minimizes the error between the generated channel output A₂G (z; θ) and the reference channel at DMRS locations y.

$${z}^{*} = arg {min}_{z} ℓ ( y , {A}_{2} G ( z ; θ ) ) \qquad ( 7 )$$

Optimization-based algorithms may be configured to optimize the latent vector with respect to a specific output sample value y. Thus, it is expected to result in a relatively small error at the expense of over-the-air optimization iterations.

In an embodiment, a GAN may be trained using channel samples from CDL-A channels with maximum delay spread of, for example, 154.5 ns. OFDM subcarrier spacing may comprise 120 KHz. A Doppler frequency may correspond to a UE moving at a speed of, for example, 5 km/hr. Each channel sample may comprise a 14×1 delay-domain vector (a truncated version of the CIR where only the non-zero paths are used for training).

In an embodiment, an inference stage may comprise a “warm start” process. A warm start process may comprise a generator input z being initialized using the input optimized for a previous channel sample. This process may leverage the high time-correlation of the channel at a low Doppler value.

For a PDSCH a subframe frequency-time grid K×L with K subcarriers and L OFDM symbols. A simplified CDL channel model at subcarrier k for OFDM symbol l_{DMRS} carrying the DMRS may be represented by:

$${H}_{{l}_{DMRS}} ( k ) = P {\sum }_{i = 1}^{{N}_{cl}} {\sum }_{j = 1}^{{N}_{ray}} {α}_{i , j} ( k ) {a}_{r} ( {ϕ}_{i , j}^{r} , {θ}_{i , j}^{r} ) {{a}_{t} ( {ϕ}_{i , j}^{t} , {θ}_{i , j}^{t} )}^{H} \qquad ( 8 )$$

where P is the normalized power, N_{cl} is the number of clusters, N_{ray} is the number of rays, α_{i,j} is the complex path gain of the j^{th} ray and the i^{th} cluster. The azimuth and elevation angles of arrival and departure are given by

$${ϕ}_{i , j}^{r} , {θ}_{i , j}^{r} , {ϕ}_{i , j}^{t} , {θ}_{i , j}^{t} ,$$

respectively. The angle of arrival (AoA) is defined as the angle at which a signal arrives at a receiver, indicating the direction of the transmitter, whereas the angle of departure (AoD) is the angle at which a signal leaves a transmitter to be received by a device.

In equation 8, it is assumed that the impact of the pulse shape is included in α_{i,j}(k). The vectors

$${a}_{r} ( {ϕ}_{i , j}^{r} , {θ}_{i , j}^{r} ) and {a}_{t} ( {ϕ}_{i , j}^{t} , {θ}_{i , j}^{t} )$$

are the normalized receive and transmit antenna array response which cover the relative angle of arrival and departure shift of each ray.

Note that in the CDL model given in equation (8), the system time resolution may play an important role in representing the CDL channel accurately. This is because each ray may be associated with an analog (continuous) time delay which may translate to fractional time samples in the corresponding digital (discrete) domain based on the system time resolution.

5G NR describes 5 CDL channel models and specifies the parameters for each model including N_{cl}, N_{ray}, angles of arrival and departure, and mean power delay profile (PDP) across clusters.

Unlike a tap-delay-line (TDL) channel model which may be wide-sense-stationary, characteristics of a CDL channel are not fully described by PDP and Doppler spread. Thus, it is expected that using a minimum mean square error (MMSE) filter for channel estimation would be sub-optimal for CDL channels since it only utilizes the PDP and Doppler information. However, estimating all the above parameters of the CDL channel model is not feasible. This renders the CDL channel a good candidate for AI-based channel estimation algorithms, where learning the data directly from actual samples may be more efficient than traditional signal processing algorithms based on an incomplete and/or inaccurate stochastic model.

In 5G NR, a PDSCH allocation may consist of a number of OFDM symbols N_{OFDM}≤14 and a group of subcarriers N_{SC}=12 N_{RB}, where N_{RB} is the number of allocated resource blocks with 12 subcarriers each.

The received signal Yₗ_{_{DMRS}}(k)ϵ [symbol] at subcarrier k and OFDM symbol l_{DMRS} may be represented by:

$${Y}_{{l}_{DMRS}} ( k ) = {H}_{{l}_{DMRS}} ( k ) {X}_{{l}_{DMRS}} ( k ) + {V}_{{l}_{DMRS}} ( k ) \qquad ( 9 )$$

where Hₗ_{_{DMRS}}(k)ϵ [symbol] is the FD channel, Xₗ_{_{DMRS}}(k)ϵ [symbol] is the transmitted precoded signal, and Vₗ_{_{DMRS}}(k)ϵ [symbol] , is thermal noise where Vₗ_{_{DMRS}}(k)˜ [symbol] (0, σ²).

Although two-dimensional (2D) channel estimation is generally more optimal than two consecutive one-dimensional (1D) channel estimations, it is computationally expensive and the performance advantage does not always justify the added complexity. Thus, some embodiments include a sequence of 1D channel estimations, first in the frequency dimension (across subcarriers), then in the time dimension (across OFDM symbols).

In 1D frequency domain CE, a DMRS may be used to descramble a received signal. The least-squares (LS) channel estimate vector ĥ_{LS} is obtained at the DMRS subcarriers {k_{DMRS}} at the OFDM symbols {l_{DMRS}} that contain a DMRS signal as follows:

$${\hat{h}}_{LS} = {H}_{{l}_{DMRS}} ( {k}_{DMRS} ) + noise \qquad ( 10 )$$

where the noise term is obtained by applying the DMRS descrambling to thermal noise.

For an LMMSE channel estimation algorithm, after obtaining the LS channel estimate, frequency domain channel estimation may be performed through linear filtering. A frequency-domain minimum-mean-squared-error (FD-MMSE) filter may take into consideration the frequency-domain correlation among different subcarriers which, in turn, may require an estimate of the channel PDP.

In some embodiments, a frequency domain LMMSE channel estimate may be ĥₗ_{_{DMRS}}(k)ϵ [symbol] , and ĥ_{LS} may be the LS channel estimate from equation (10). The LMMSE channel estimate may thus be represented by:

$${\hat{h}}_{{l}_{DMRS}} = E [ {h}_{{l}_{DMRS}} {\hat{h}}_{LS}^{H} ] {( E [ {\hat{h}}_{LS} {\hat{h}}_{LS}^{H} ] )}^{- 1} {\hat{h}}_{LS} \qquad ( 11 )$$

Expectations in equation (11) may be calculated in terms of the auto-covariance and cross-covariance matrices R_{p,p} and R_{h,p}. The former is the auto-covariance matrix of the channel at the DMRS subcarriers, while the latter is the cross-covariance matrix between the channel at DMRS and general subcarriers. The correlation between 2 time-frequency points of the channel may be defined as:

$${R}_{{h}_{{k}_{1} , {l}_{1}} , {h}_{{k}_{2} , {l}_{2}}} = E [ {h}_{{k}_{1} , {l}_{1}} {h}_{{k}_{2} , {l}_{2}}^{H} ] \qquad ( 12 )$$

Using the PDP of the channel, the correlation between the channel at two different subcarriers belonging to the same OFDM symbol may be estimated by:

$${R}_{{k}_{1} , {k}_{2}} = {\sum }_{i = 0}^{{L}_{c} - 1} {P}_{i} {e}^{- j 2 π ( {k}_{1} - {k}_{2} ) Δ f {τ}_{i}} \qquad ( 13 )$$

where L_{c} is the number of channel taps in the delay-domain, Pᵢ and τᵢ are the power and delay of the ith channel tap, respectively, and Δf is the subcarrier spacing.

Note that for the auto-covariance matrix R_{p,p}, k₁=k₂ in equation (13), and for the cross-covariance matrix R_{h,p}, k₁≠k₂ in equation (13).

Assuming a TDL channel model, which is a clear model mismatch for CDL channels but used only to reduce estimation complexity, the expectations in equation (11) may be replaced by the corresponding covariance matrices as follows:

$${\hat{h}}_{{l}_{DMRS}} = {{R}_{h , p} ( {R}_{p , p} + {σ}^{2} I )}^{- 1} {\hat{h}}_{LS} \qquad ( 14 )$$

where σ² is the variance of the noise term in equation (10).

In 5G NR, channel estimation is typically performed one physical resource group (PRG) at a time if narrow-band precoding is used. For example, a PRG size of 2 (i.e., N_{RB}=2), with 6 DMRS subcarriers per resource block (RB), implies that R_{p,p}ϵ [symbol] . As per equation (14), MMSE channel estimation requires a matrix inversion of a size 12×12 matrix. Note also that noise variance estimation may be required.

In some embodiments, frequency domain CE may be followed by time domain CE, and may comprise linear filtering as well. A linear filter may comprise an MMSE filter. A linear filter may comprise a linear interpolator. In case of a single OFDM symbol carrying DMRS in the grid, the time domain CE filtering may reduce to repetition of the channel vector estimated at the DMRS symbol.

Instead of training the WGAN algorithm to generate samples of the desired FD vector directly, a WGAN may be trained to generate samples of the M×1 channel vector m in the delay-domain (DD). This is because the channel in the DD is sparse with only a few significant taps and a practical maximum delay spread. Thus, the WGAN model may be trained to generate the DD channel. During the inference phase, the DD channel may be estimated. Once the DD channel vector is estimated, it may be multiplied by a partial FFT matrix A₁ in order to obtain the corresponding FD channel vector as shown in (15).

$$[ \begin{matrix}{h}_{0} \\ {h}_{1} \\ ⋮ \\ {h}_{N - 1}\end{matrix} ] = [ \begin{matrix}{A}_{0 , 0} & & {A}_{0 , 1} & … & {A}_{0 , M - 1} \\ & ⋮ & & ⋱ & ⋮ \\ {A}_{N - 1 , 0} & & {A}_{N - 1 , 1} & ⋯ & {A}_{N - 1 , M - 1}\end{matrix} ] [ \begin{matrix}{m}_{0} \\ {m}_{1} \\ ⋮ \\ {m}_{M - 1}\end{matrix} ] \qquad ( 15 )$$

Note that, generally M≥ [symbol] ₘₐₓ where [symbol] ₘₐₓ is the maximum delay spread of the channel.

For example, a conventional WGAN generator loss function may be represented by the following:

$${L}_{G} = - {E}_{\hat{x} ∼ {P}_{g}} [ D ( \hat{x} ) ] \qquad ( 16 )$$

where D(\hat{x}) is the discriminator (critic) output for samples \hat{x} generated by the generator.

Some embodiments may include a modified generator loss function. A regular loss function may be used in most training epochs, but once, for example, every 1000 epochs, the instantaneous generator version may be used as part of a channel estimation algorithm using data independent from that used for training. An estimation NMSE may be calculated and added to the generator loss function with a ratio α as follows:

$$( 17 )$$

$${L}_{G} = \{ \begin{matrix}- {E}_{\hat{x} ∼ {P}_{g}} [ D ( \hat{x} ) ] & for epoch \neq 0 , 1000 , 2000 , … etc . \\ - α {E}_{\hat{x} ∼ {P}_{g}} [ D ( \hat{x} ) ] + ( 1 - α ) NMSE & for epoch \neq 0 , 1000 , 2000 , … etc .\end{matrix}$$

Some embodiments may utilize a generator trained offline as part of a channel estimation algorithm. A channel estimation algorithm may be configured to take an initial latent vector z as an input to the generator. The generator may be configured to output the estimated delay-domain channel CIR vector \hat{m}. A frequency domain DMRS channel vector ĥ_{DMRS} may be obtained through multiplying the delay-domain channel with a partial Fourier transform matrix A₂ at the DMRS frequency locations. The generated DMRS vector may be compared to the LS DMRS channel estimate ĥ_{LS} and the error may be calculated as follows:

$$e = {‖ {\hat{h}}_{LS} - {\hat{h}}_{DMRS} ‖}^{2} + {λ}_{reg} {‖ z ‖}^{2} \qquad ( 18 )$$

where λ_{reg} is a regularization parameter that ensures that the optimization of z favors a latent vector with a small norm for stability.

After a fixed number of optimization loops or when the error converges to an acceptable value, the final \hat{m} is used to obtain the frequency domain channel vector at the data locations, denoted as ĥ_{wGAN}.

Some embodiments may include a representation of a received signal which is a truncated, sampled Fourier transform of the signal in the form of the frequency domain channel vector sampled at specific subcarriers, namely the DMRS subcarriers. This may be represented by equation (15). There may be a one-to-one mapping between the delay-domain channel signal and the truncated sampled FFT representation of that signal.

In the channel estimation phase, a DMRS channel least-squares estimate ĥ_{LS} may be utilized as the initial value for the latent vector, i.e., Z₀=ĥ_{LS}. This is followed by iterative optimization of the latent vector. Note that an explicit step of transformation may not be needed in this case since during channel estimation, the LS channel estimate may be available through the DMRS signal received, which may be the equivalent of a noisy version of the transformed signal.

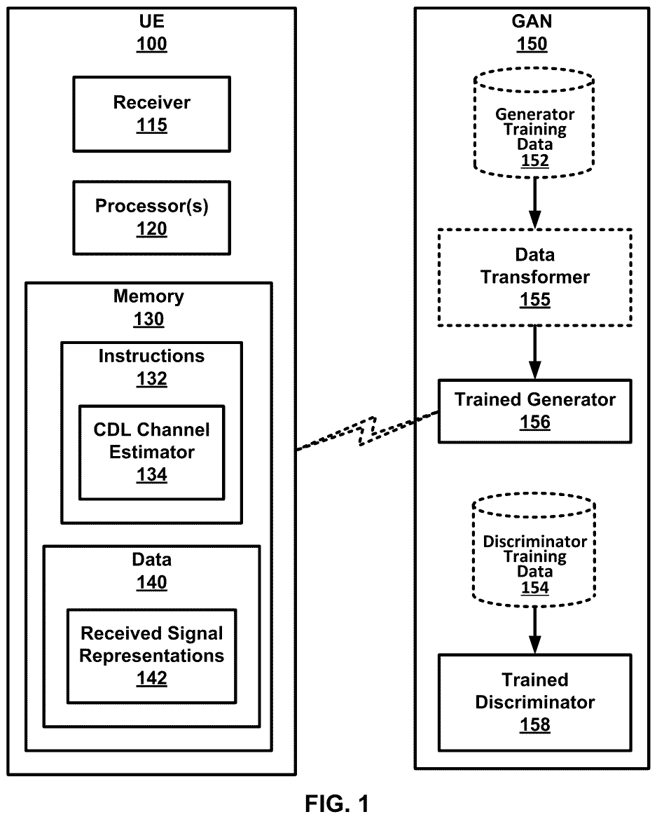

FIG. 1 is a block diagram illustrating a UE 100 in communication with a trained generator 156, according to an embodiment.

Referring to FIG. 1, UE 100 may comprise a receiver 115. Receiver 115 may be configured to receive a DMRS carried by an OFDM symbol. UE 100 may be configured to communicate with trained generator 156. The trained generator may be part of GAN 150. GAN 150 may comprise generator training data 152. GAN 150 may comprise data transformer 155. Data transformer 155 may be configured to transform, through utilization of a Fourier transform, sample, and truncate the generator training data to produce a latent input to a generator. The generator may be trained using the latent input to generate trained generator 156. GAN 150 may comprise discriminator training data 154. After training, GAN 150 may comprise trained discriminator 158.

UE 100 may comprise one or more processors 120. UE 100 may comprise memory 130. Memory 130 may comprise instructions 132. The instructions 132 may comprise CDL channel estimator 134. CDL channel estimator 134 may be configured to conduct CDL channel estimation. Memory 130 may comprise data 140. Data 140 may comprise representations of a received signal 142. Representations of a received signal 142 may be truncated, sampled, and transformed through utilization of a Fourier transform by CDL channel estimator 134. The truncated, sampled, Fourier transformed representations of the received signal may be used as a latent input to trained generator 156.

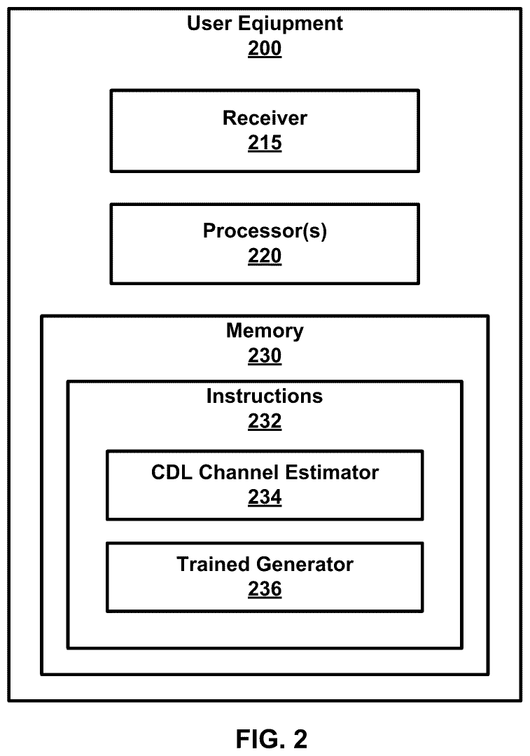

FIG. 2 is a block diagram illustrating a UE 200 including a trained generator 236, according to an embodiment.

Referring to FIG. 2, UE 200 may comprise a receiver 215. Receiver 215 may be configured to receive a DMRS carried by an OFDM symbol. UE 200 may comprise one or more processors 220. UE 200 may comprise memory 230. Memory 230 may comprise instructions 232. The instructions 232 may comprise CDL channel estimator 234. CDL channel estimator 234 may be configured to conduct CDL channel estimation. The instructions 232 may comprise trained generator 236. Trained generator 236 may have been previously trained as part of a GAN.

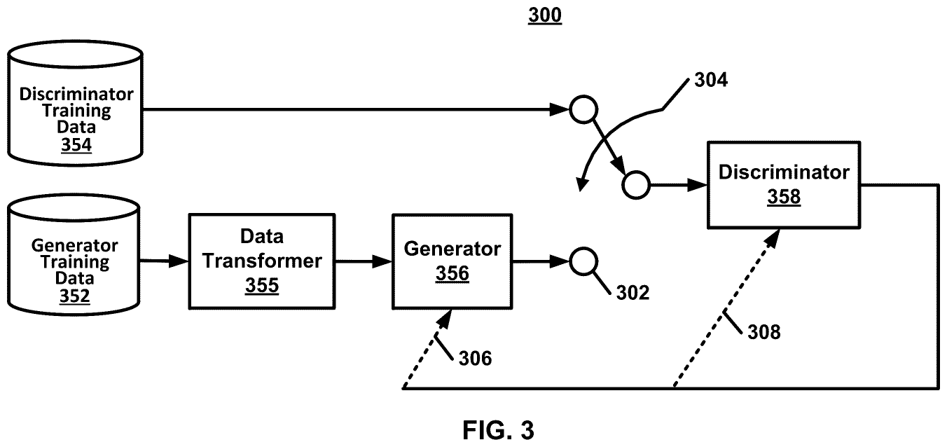

FIG. 3 is a block diagram illustrating a TA-GAN 300 in a training phase, according to an embodiment.

Referring to FIG. 3, TA-GAN 300 may comprise discriminator training data 354. TA-GAN 300 may comprise a discriminator 358. TA-GAN 300 may comprise generator training data 352. TA-GAN 300 may comprise data transformer 355. TA-GAN 300 may comprise generator 356. Data transformer 355 may be configured to transform, through utilization of a Fourier transform, sample, and truncate generator training data 352 to produce a latent input to generator 356. With each iteration of TA-GAN 300, output 302 of generator 356 may comprise a generated data sample. TA-GAN 300 may comprise switch 304. Discriminator 358 may be configured to use switch 304 to select an input from discriminator training data 354 or output 302 for classification. Discriminator 358 may be configured to minimize discriminator loss function 308. Generator 356 may be configured to minimize generator loss function 306.

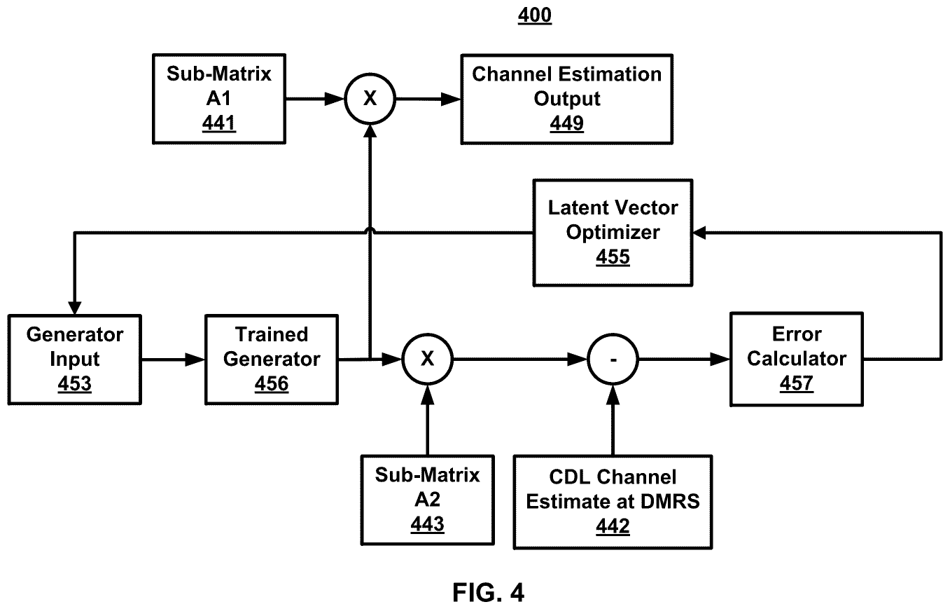

FIG. 4 is a block diagram illustrating a WGAN channel estimation 400, according to an embodiment.

Referring to FIG. 4, WGAN-CE 400 may comprise generator input 453. Generator input 453 may comprise latent input vector. WGAN-CE 400 may comprise trained generator 456. Trained generator 456 may be previously trained as part of WGAN training. The output of trained generator 456 may comprise an estimated delay-domain channel CIR vector. WGAN-CE 400 may comprise sub-matrix A1 441. WGAN-CE 400 may comprise sub-matrix A2 443. Sub-matrix A1 441 and sub-matrix A2 443 may be constructed by sampling and truncating a Fast Fourier Transform (FFT) matrix A at different locations corresponding to data and DMRS locations, respectively. A frequency domain DMRS channel vector may result from multiplying the estimated delay-domain channel CIR vector with sub-matrix A2 443. WGAN-CE 400 may comprise CDL channel estimate at DMRS locations 442. CDL channel estimate at DMRS locations 442 may comprise a LS channel estimate. CDL channel estimate at DMRS locations 442 may be de-noised. The frequency domain DMRS channel vector may be compared to CDL channel estimate at DMRS locations 442. WGAN-CE 400 may comprise error calculator 457. Error calculator 457 may be configured to calculate the error as shown in equation (18).

WGAN-CE 400 may comprise latent vector optimizer 455. Latent vector optimizer 455 may be configured to modify the latent input vector. Latent vector optimizer 455 may comprise a steepest descent algorithm. After a fixed number of optimization loops or when the error converges to an acceptable value, the final estimated delay-domain channel CIR vector may be used to obtain the frequency domain channel vector at the data locations, channel estimation output 449.

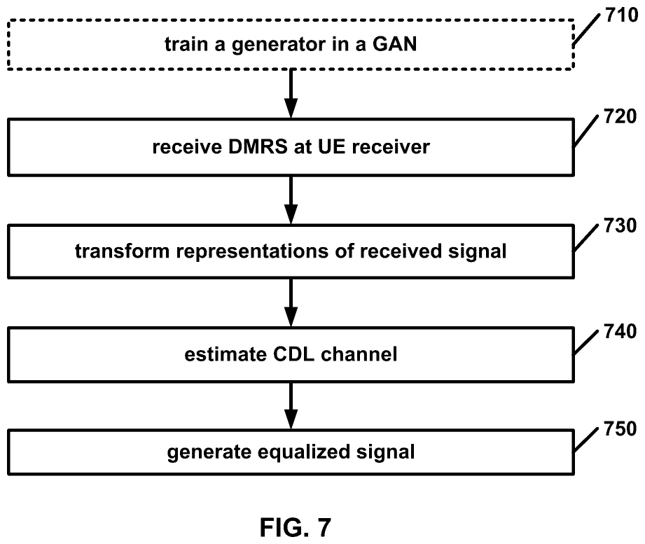

FIG. 7 is a diagram illustrating a channel estimation model 500 for an OFDM subframe, according to an embodiment.

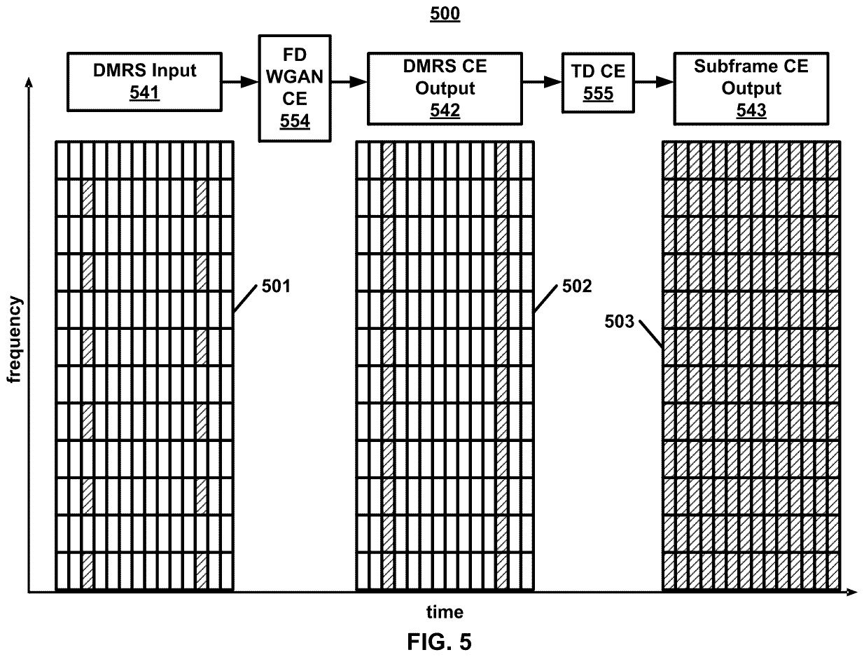

Referring to FIG. 5, received signals may be illustrated on ports 501, 502, and 503. The received signals may be represented by rows of subcarriers and columns of OFDM symbols. On port 501, each of two symbols may comprise a DMRS. On port 701, the shaded blocks may represent the DMRS channel available. On port 702, the shaded blocks may represent all estimated channel locations after FD WGAN (which may include both DMRS and data positions). On port 703, the shaded blocks may represent all the estimated channel locations after the TD CE block.

Channel estimation model 500 may comprise a 1D frequency domain WGAN channel estimation module 554. The 1D frequency domain WGAN channel estimation module 554 may utilize an LS channel estimate of DMRS input 541 to produce a DMRS channel estimation output 542. Channel estimation model 500 may comprise a time domain channel estimation 555. Time domain channel estimation 555 may be based on a Doppler estimate. Time domain channel estimation 555 may utilize the DMRS channel estimation output 542 to produce a channel estimation for the remaining OFDM symbols of the subframe 543. For the front-loaded DMRS example in the FIG. 5 (i.e., where only one OFDM symbol carries DMRS) 1D frequency domain WGAN channel estimation is performed at the OFDM carrying the DMRS.

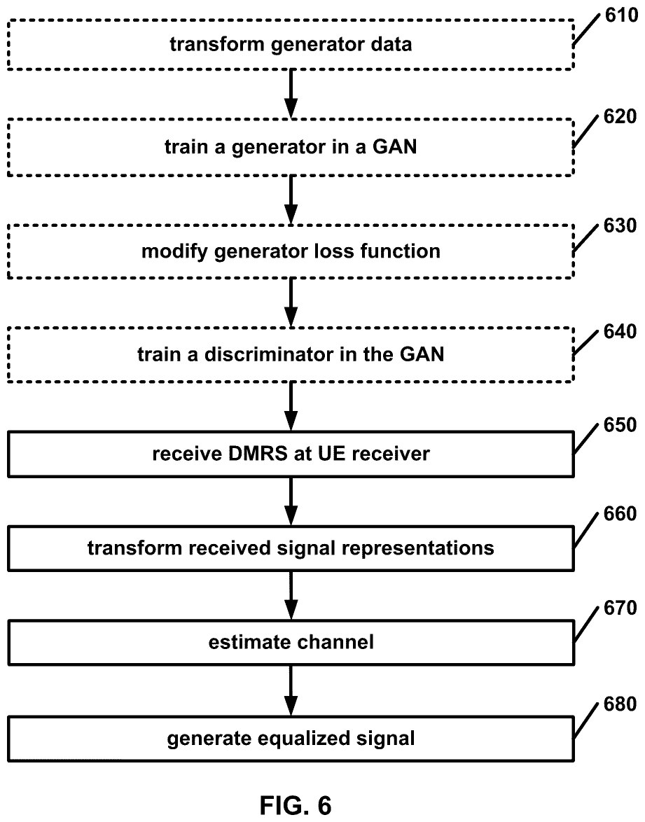

FIG. 6 is a flowchart illustrating a method for training a GAN and estimating a channel, according to an embodiment.

Referring to FIG. 6, generator training data may be transformed at 610. A generator in a GAN may be trained at 620. The generator may be trained with the transformed training data. A generator loss function may be modified at 630. The generator loss function may be modified during the training of the generator. A discriminator in the GAN may be trained at 640. The discriminator may be trained with discriminator training data. A noisy DMRS may be received at a UE receiver at 650. Representations of the received signal may be transformed at 660. Transformed representations of the received signal may be sampled and truncated. A channel may be estimated at 670. The channel may be estimated in a frequency domain. The channel estimation may be based on using the transformed representations of the received signal as latent input to the trained generator. An equalized signal may be generated from the received signal at 680. The equalized signal may be generated using the estimated CDL channel.

FIG. 7 is a flowchart illustrating a method for estimating a CDL channel, according to an embodiment.

Referring to FIG. 7, a generator in a GAN may be trained at 710. DMRS may be received at a UE receiver at 720. Representations of the received signal may be transformed at 730. A CDL channel may be estimated at 740. The channel estimation may be based on using the transformed representations of the received signal as latent input to the trained generator. An equalized signal may be generated from the received signal at 750. The equalized signal may be generated using the estimated CDL channel.

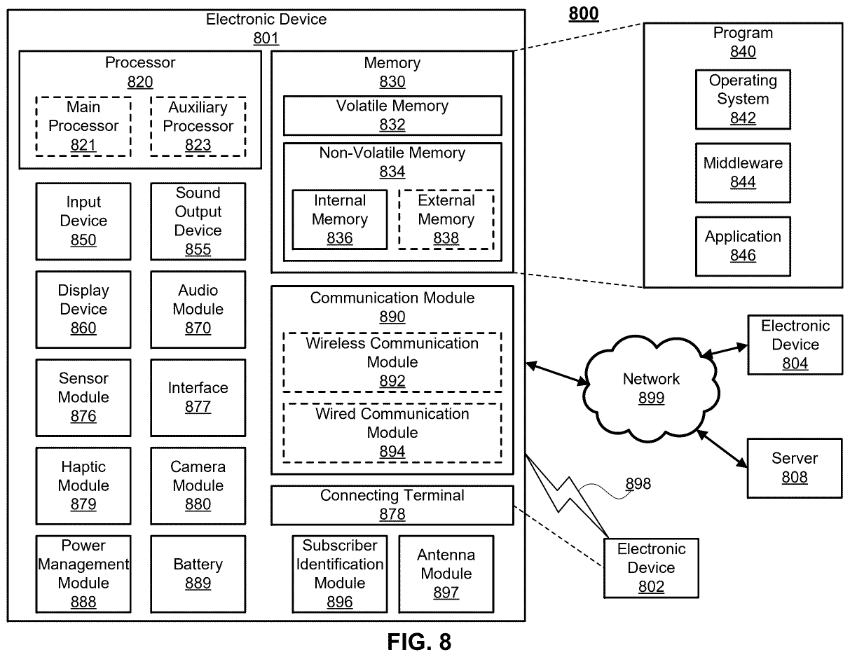

FIG. 8 is a block diagram of an electronic device in a network environment 800, according to an embodiment. For example, an electronic device may comprise a UE.

Referring to FIG. 8, an electronic device 801 in a network environment 800 may communicate with an electronic device 802 via a first network 898 (e.g., a short-range wireless communication network), or an electronic device 804 or a server 808 via a second network 899 (e.g., a long-range wireless communication network). The electronic device 801 may communicate with the electronic device 804 via the server 808. The electronic device 801 may include a processor 820, a memory 830, an input device 850, a sound output device 855, a display device 860, an audio module 870, a sensor module 876, an interface 877, a haptic module 879, a camera module 880, a power management module 888, a battery 889, a communication module 890, a subscriber identification module (SIM) card 896, or an antenna module 897. In one embodiment, at least one (e.g., the display device 860 or the camera module 880) of the components may be omitted from the electronic device 801, or one or more other components may be added to the electronic device 801. Some of the components may be implemented as a single integrated circuit (IC). For example, the sensor module 876 (e.g., a fingerprint sensor, an iris sensor, or an illuminance sensor) may be embedded in the display device 860 (e.g., a display).

The processor 820 may execute software (e.g., a program 840) to control at least one other component (e.g., a hardware or a software component) of the electronic device 801 coupled with the processor 820 and may perform various data processing or computations.

As at least part of the data processing or computations, the processor 820 may load a command or data received from another component (e.g., the sensor module 876 or the communication module 890) in volatile memory 832, process the command or the data stored in the volatile memory 832, and store resulting data in non-volatile memory 834. The processor 820 may include a main processor 821 (e.g., a central processing unit (CPU) or an application processor (AP)), and an auxiliary processor 823 (e.g., a graphics processing unit (GPU), an image signal processor (ISP), a sensor hub processor, or a communication processor (CP)) that is operable independently from, or in conjunction with, the main processor 821. Additionally or alternatively, the auxiliary processor 823 may be adapted to consume less power than the main processor 821, or execute a particular function. The auxiliary processor 823 may be implemented as being separate from, or a part of, the main processor 821.

The auxiliary processor 823 may control at least some of the functions or states related to at least one component (e.g., the display device 860, the sensor module 876, or the communication module 890) among the components of the electronic device 801, instead of the main processor 821 while the main processor 821 is in an inactive (e.g., sleep) state, or together with the main processor 821 while the main processor 821 is in an active state (e.g., executing an application). The auxiliary processor 823 (e.g., an image signal processor or a communication processor) may be implemented as part of another component (e.g., the camera module 880 or the communication module 890) functionally related to the auxiliary processor 823.

The memory 830 may store various data used by at least one component (e.g., the processor 820 or the sensor module 876) of the electronic device 801. The various data may include, for example, software (e.g., the program 840) and input data or output data for a command related thereto. The memory 830 may include the volatile memory 832 or the non-volatile memory 834. Non-volatile memory 834 may include internal memory 836 and/or external memory 838.

The program 840 may be stored in the memory 830 as software, and may include, for example, an operating system (OS) 842, middleware 844, or an application 846.

The input device 850 may receive a command or data to be used by another component (e.g., the processor 820) of the electronic device 801, from the outside (e.g., a user) of the electronic device 801. The input device 850 may include, for example, a microphone, a mouse, or a keyboard.

The sound output device 855 may output sound signals to the outside of the electronic device 801. The sound output device 855 may include, for example, a speaker or a receiver. The speaker may be used for general purposes, such as playing multimedia or recording, and the receiver may be used for receiving an incoming call. The receiver may be implemented as being separate from, or a part of, the speaker.

The display device 860 may visually provide information to the outside (e.g., a user) of the electronic device 801. The display device 860 may include, for example, a display, a hologram device, or a projector and control circuitry to control a corresponding one of the display, hologram device, and projector. The display device 860 may include touch circuitry adapted to detect a touch, or sensor circuitry (e.g., a pressure sensor) adapted to measure the intensity of force incurred by the touch.

The audio module 870 may convert a sound into an electrical signal and vice versa. The audio module 870 may obtain the sound via the input device 850 or output the sound via the sound output device 855 or a headphone of an external electronic device 802 directly (e.g., wired) or wirelessly coupled with the electronic device 801.

The sensor module 876 may detect an operational state (e.g., power or temperature) of the electronic device 801 or an environmental state (e.g., a state of a user) external to the electronic device 801, and then generate an electrical signal or data value corresponding to the detected state. The sensor module 876 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 877 may support one or more specified protocols to be used for the electronic device 801 to be coupled with the external electronic device 802 directly (e.g., wired) or wirelessly. The interface 877 may include, for example, a high-definition multimedia interface (HDMI), a universal serial bus (USB) interface, a secure digital (SD) card interface, or an audio interface.

A connecting terminal 878 may include a connector via which the electronic device 801 may be physically connected with the external electronic device 802. The connecting terminal 878 may include, for example, an HDMI connector, a USB connector, an SD card connector, or an audio connector (e.g., a headphone connector).

The haptic module 879 may convert an electrical signal into a mechanical stimulus (e.g., a vibration or a movement) or an electrical stimulus which may be recognized by a user via tactile sensation or kinesthetic sensation. The haptic module 879 may include, for example, a motor, a piezoelectric element, or an electrical stimulator.

The camera module 880 may capture a still image or moving images. The camera module 880 may include one or more lenses, image sensors, image signal processors, or flashes. The power management module 888 may manage power supplied to the electronic device 801. The power management module 888 may be implemented as at least part of, for example, a power management integrated circuit (PMIC).

The battery 889 may supply power to at least one component of the electronic device 801. The battery 889 may include, for example, a primary cell which is not rechargeable, a secondary cell which is rechargeable, or a fuel cell.

The communication module 890 may support establishing a direct (e.g., wired) communication channel or a wireless communication channel between the electronic device 801 and the external electronic device (e.g., the electronic device 802, the electronic device 804, or the server 808) and performing communication via the established communication channel. The communication module 890 may include one or more communication processors that are operable independently from the processor 820 (e.g., the AP) and supports a direct (e.g., wired) communication or a wireless communication. The communication module 890 may include a wireless communication module 892 (e.g., a cellular communication module, a short-range wireless communication module, or a global navigation satellite system (GNSS) communication module) or a wired communication module 894 (e.g., a local area network (LAN) communication module or a power line communication (PLC) module). A corresponding one of these communication modules may communicate with the external electronic device via the first network 898 (e.g., a short-range communication network, such as BLUETOOTH™, wireless-fidelity (Wi-Fi) direct, or a standard of the Infrared Data Association (IrDA)) or the second network 899 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 892 may identify and authenticate the electronic device 801 in a communication network, such as the first network 898 or the second network 899, using subscriber information (e.g., international mobile subscriber identity (IMSI)) stored in the subscriber identification module 896.

The antenna module 897 may transmit or receive a signal or power to or from the outside (e.g., the external electronic device) of the electronic device 801. The antenna module 897 may include one or more antennas, and, therefrom, at least one antenna appropriate for a communication scheme used in the communication network, such as the first network 898 or the second network 899, may be selected, for example, by the communication module 890 (e.g., the wireless communication module 892). The signal or the power may then be transmitted or received between the communication module 890 and the external electronic device via the selected at least one antenna.

Commands or data may be transmitted or received between the electronic device 801 and the external electronic device 804 via the server 808 coupled with the second network 899. Each of the electronic devices 802 and 804 may be a device of a same type as, or a different type, from the electronic device 801. All or some of operations to be executed at the electronic device 801 may be executed at one or more of the external electronic devices 802, 804, or 808. For example, if the electronic device 801 should perform a function or a service automatically, or in response to a request from a user or another device, the electronic device 801, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 801. The electronic device 801 may provide the outcome, with or without further processing of the outcome, as at least part of a reply to the request. To that end, a cloud computing, distributed computing, or client-server computing technology may be used, for example.

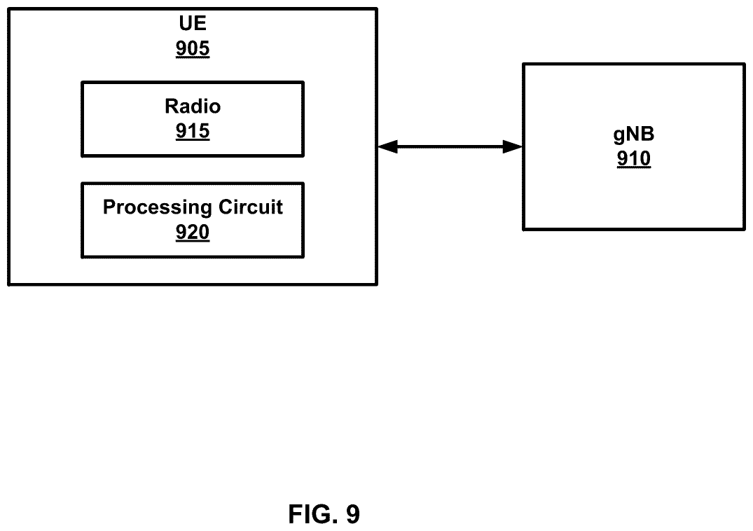

FIG. 9 shows a system including a UE 905 and a gNB 910, in communication with each other. The UE may include a radio 915 and a processing circuit (or a means for processing) 920, which may perform various methods disclosed herein, e.g., the method illustrated in FIG. 9. For example, the processing circuit 920 may receive, via the radio 915, transmissions from the network node (gNB) 910, and the processing circuit 920 may transmit, via the radio 915, signals to the gNB 910.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively, or additionally, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially-generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A method comprising:
receiving a signal at a user equipment (UE) receiver;
estimating a cluster delay line (CDL) channel at the receiver in a frequency domain using a received noisy demodulation reference signal (DMRS) through utilization of a trained generator in a generative adversarial network (GAN), the trained generator using truncated, sampled Fourier transform representations of the received signal as latent input; and
using the estimate of the CDL channel, generating an equalized signal from the received signal.

2. The method of claim 1, further comprising training, using generator training data including CDL channel samples, a generator to generate the trained generator.

3. The method of claim 1, wherein the DMRS is carried by an orthogonal frequency division multiplexing (OFDM) symbol.

4. The method of claim 1, further comprising training, using discriminator training data including CDL channel samples, a discriminator in the GAN.

5. The method of claim 2, further comprising modifying a generator loss function during the training of the generator to include a normalized mean square error (NMSE).

6. The method of claim 5, wherein the NMSE is a result from using a current iteration of the trained generator.

7. A user equipment (UE) comprising:
at least one processor;
a receiver; and
memory that stores instructions, which when executed by the at least one processor, control the UE to:
receive a signal at the receiver;
estimate a cluster delay line (CDL) channel received at the receiver in a frequency domain using a received noisy demodulation reference signal (DMRS) through utilization of a trained generator, the trained generator using truncated, sampled Fourier transform representations of the received signal as latent input; and
generate an equalized signal from the received signal using the estimate of the CDL channel.

8. The UE of claim 7, wherein the trained generator is trained using generator training data including CDL channel samples.

9. The UE of claim 7, wherein the DMRS is carried by an orthogonal frequency division multiplexing (OFDM) symbol.

10. The UE of claim 7, wherein the generator is trained in a generative adversarial network (GAN).

11. The UE of claim 10, wherein the GAN is configured to transform, through utilization of a Fourier transform, sample, and truncate generator training data as latent input to the generator.

12. The UE of claim 10, wherein the GAN includes a discriminator, and the discriminator is trained using discriminator training data including CDL channel samples.

13. The UE of claim 8, wherein a generator loss function is modified during the training of the generator to include a normalized mean square error (NMSE).

14. A method performed by a user equipment (UE), the method comprising:
receiving a noisy demodulation reference signal (DMRS);
estimating a CDL channel in a frequency domain using the received DMRS through utilization of a trained generator, the trained generator using truncated, sampled Fourier transform representations of the received signal as latent input; and
using the estimate of the CDL channel, generating an equalized signal from the received signal.

15. The method of claim 14, wherein the trained generator is trained using generator training data including CDL channel samples.

16. The method of claim 14, wherein the DMRS is carried by an orthogonal frequency division multiplexing (OFDM) symbol.

17. The method of claim 14, wherein the generator is trained in a generative adversarial network (GAN).

18. The method of claim 17, wherein the GAN is configured to transform, through utilization of a Fourier transform, sample, and truncate generator training data as latent input to the generator.

19. The method of claim 17, wherein the GAN includes a discriminator, and the discriminator is trained using discriminator training data including CDL channel samples.

20. The method of claim 15, wherein a generator loss function is modified during the training of the generator to include a normalized mean square error (NMSE).
